(19) United States
(12) Patent Application Publication
(10) Pub. No.: US 2024/0395152 A1
(43) Pub. Date: Nov. 28, 2024

(54) Large-scale UAV mission planning method and system

(71) Applicant: Beihang University, Beijing (CN)

(72) Inventors: Yumeng LI, Beijing (CN); Ruofei SUN, Beijing (CN); Tong GUO, Beijing (CN); Yinan JIANG, Beijing (CN); Shenwen CHEN, Beijing (CN); Wenbo DU, Beijing (CN)

(73) Assignee: Beihang University, Beijing (CN)

(21) Appl. No.: 18/543,444

(22) Filed: Dec. 18, 2023

(30) Foreign Application Priority Data
May 26, 2023 (CN) 202310607922.8

(51) Int. Cl. G08G 5/00; G06Q 10/0631

(52) U.S. Cl. CPC G08G 5/0069; G06Q 10/06311; G08G 5/0039; B64U 2101/00; B64U 2101/57

(57) ABSTRACT

A large-scale UAV mission planning method includes constructing an objective function and its constraints; initializing a mission sequence and inserting customers into the mission sequence with the smallest objective function value to obtain a plurality of initial mission sequences; iteratively performing the update operations on the plurality of initial mission sequences. Fast acquisition of optimal missions is achieved by the invention. This invention solves the existing problem of not being able to obtain the optimal mission due to the complex and time-consuming calculation method and the difficulty of convergence of the algorithm.

### CROSS-REFERENCE TO RELATED APPLICATIONS

This application claims priority to Chinese Patent Application No. 202310607922.8 filed on May 26, 2023, the disclosure of which is hereby incorporated by reference in its entirety.

### BACKGROUND

With the rapid development of unmanned aerial vehicle (UAV) technology, the flexibility, speed and low cost characteristics of UAVs have provided them with great application value in many industries. Especially in post-disaster rescue scenarios, UAVs are deployed quickly, act flexibly, and are not constrained by terrain, and can quickly reach the disaster site to complete the material delivery mission. In disaster scenarios such as mountain fires and earthquakes, how to reduce the waiting time for material delivery at the disaster site is the key to reducing losses. Therefore, in the presence of multiple UAV departure points and UAVs with limited capacity and flight distance, how to plan out the route customer service sequence of each UAV so that all customers are served and only once and the material delivery waiting time of all customers is minimized is the current cumulative UAV mission planning problem with capacity constraints at multiple field stations that deserves close attention.

The solution methods of domestic and foreign researchers are mainly classified into deterministic methods and heuristic methods. Deterministic methods include nonlinear integer planning solvers, dynamic planning, etc. The advantage of such methods is that they model the problem to be solved as a mixed integer linear programming problem and can obtain optimal or near-optimal solution results. However, there is no uniform treatment of different problems by such methods, which need to be analyzed and handled by the specific nature of different problems, and in addition, when the scale of the problem increases, the computational cost of the solution rises sharply, and the solution cannot be obtained in a short time on large-scale data sets. These shortcomings create a great contradiction with the required aspects of post-disaster material distribution scenarios. Heuristic methods include genetic algorithms, ant colony algorithms, local search and other intelligent optimization methods, which can find the approximate optimal solution for the current situation in a shorter time by designing a reasonable solution structure and search strategy compared with deterministic methods.

However, when the number of customers to be served is greater than 250, which can be considered as a large-scale UAV mission planning problem, the existing heuristic methods lack a suitable partitioning strategy, leading to complex algorithm solutions and low global convergence ability, which affects the quality of the mission sequence solutions; the existing local search methods traverse all neighborhoods with high overhead, and the performance of a randomly selected neighborhood is relatively poor, lacking a method to select a suitable search neighborhood.

### SUMMARY

The present invention relates to the field of unmanned aerial vehicle (UAV) technology, and in particular to a large-scale UAV mission planning method and system.

In view of the above analysis, embodiments of the present invention aim to provide a large-scale UAV mission planning method and system for solving the existing problem of not being able to obtain an optimal mission assignment sequence due to the complexity and time-consuming nature of the computational method and the difficulty of convergence of the algorithm in the face of large-scale problems.

On the one hand, embodiments of the present invention provide a large-scale UAV mission planning method comprising the steps of: constructing an objective function of the UAV mission planning problem and its constraints; initializing the mission sequence, and inserting each customer into the mission sequence with the smallest value of the respective objective function according to the change value of the objective function after inserting the customer in the mission sequence, to obtain a plurality of initial mission sequences; iteratively perform the following update operations on the plurality of initial mission sequences: using the spectral clustering algorithm to divide the plurality of initial mission sequences into a plurality of groups; according to the preset neighborhood operator, using the adaptive variable neighborhood search algorithm to optimize the mission sequences of each group of the plurality of groups in turn and then merging them to obtain a plurality of global mission sequences; if the total objective function value of the plurality of global mission sequences is smaller than the total objective function value of the plurality of initial mission sequences, then updating the plurality of initial mission sequences using the plurality of global mission sequences; performing the next round of update operation until the end condition is reached, and composing the optimal UAV mission assignment sequence by the updated plurality of initial mission sequences.

Based on the further improvement of the above method, after merging to obtain the plurality of global mission sequences, a local search algorithm is used to iteratively repair each global mission sequence in turn using each neighborhood operator, and the repaired mission sequence with the smallest objective function value is taken to update the corresponding global mission sequence; the repaired plurality of global mission sequences are obtained.

Based on the further improvement of the above method, the objective function of the UAV mission planning problem and its constraints are constructed, including: constructing an objective function with the cumulative time for each UAV to reach a customer and the shortest total cumulative time for each UAV to reach each customer in the mission sequence from the warehouse as the objective; constructing constraints based on the number of times each customer is visited, the time for a drone to reach a customer in the same mission sequence, the maximum capacity of the supplies carried by the drone, and the remaining power of the drone to reach each customer; when calculating the objective function value of any mission sequence, if the current mission sequence satisfies all constraints, calculating the objective function value according to the objective function, otherwise, setting the objective function value to the pre-set maximum function value.

Based on further improvements of the above method, the mission sequence is initialized, and a plurality of initial mission sequences are obtained by inserting each customer into the respective mission sequence with the smallest objective function value based on the change value of the objective function value after the insertion of the customer in the mission sequence, including: constructing, for each UAV, a plurality of first mission sequences using the warehouse to which it belongs as the starting point of the mission sequence; placing all customers into the set to be inserted; iteratively performing the following update operations on the plurality of first mission sequences: inserting each customer in the set to be inserted into each first mission sequence in turn, calculating the change value of the objective function value of each first mission sequence before and after the insertion, and obtaining the difference between the second minimum change value and the minimum change value; comparing the difference value corresponding to each customer, inserting the customer with the largest difference value into the first mission sequence corresponding to the minimum change value of that customer and deleting the customer from the set to be inserted, and performing the next update operation until the set to be inserted is empty; screening out the first mission sequence containing the customer from the updated plurality of first mission sequences, and inserting the warehouse nearest to the last customer into the tail of the screened out plurality of first mission sequences as the end of the mission sequence, respectively, to obtain the plurality of initial mission sequences.

Based on a further improvement of the above method, a spectral clustering algorithm is used to divide the plurality of initial mission sequences into a plurality of groups, comprising: based on the coordinates of latitude and longitude where each node in each initial mission sequence is located, and the number of customers and warehouses, the coordinates of the center of gravity of each initial mission sequence are calculated as input samples by the following formula:

$${b}_{m} = ( {b}_{m}^{x} , {b}_{m}^{y} ) = ( \frac{1}{\vert {V}_{m} \vert} {\sum }_{i ∈ {V}_{m}} {x}_{i} , \frac{1}{\vert {V}_{m} \vert} {\sum }_{i ∈ {V}_{m}} {y}_{i} )$$

Where (bₘ^{x},bₘ^{y}) denotes the longitude coordinates and latitude coordinates of the center of gravity bₘ of the m-th mission sequence Vₘ; |Vₘ| denotes the number of nodes in the m-th mission sequence, said nodes including customers and warehouses; xᵢ denotes the longitude coordinates of the i-th node; yᵢ denotes the latitude coordinates of the i-th node.

inputting the input samples, the pre-set number of feature dimensions, and the number of customers in each group are input into a spectral clustering algorithm to cluster a plurality of initial mission sequences into a plurality of groups.

Based on a further improvement of the above method, an adaptive variable neighborhood search algorithm is used to sequentially optimize the mission sequences of each group based on the pre-defined neighborhood operator, comprising: performing the following iterative optimization operations on the mission sequence of each group: initializing the global optimal solution, the optimal solution of the previous round iteration and the neighborhood operator weights, and setting the maximum number of executions; in each execution, selecting a neighborhood operator by use of a roulette wheel selection algorithm based on the weights of each neighborhood operator; computing a first solution for each group based on the selected neighborhood operator; obtaining a second solution by applying a variable neighborhood descent algorithm to the first solution; updating the performance record values of the selected neighborhood operator, the global optimal solution and the current round iteration optimal solution based on the global optimal solution, the current round iteration optimal solution, the previous round iteration optimal solution and the second solution, updating each group with the global optimal solution for the next execution until the maximum number of executions is reached, updating the previous round iterative optimal solution for each group with the current round iterative optimal solution, updating the weights of each neighborhood operator according to the preset weight update rate and the performance record value of each neighborhood operator, and carrying out the next round of iterative optimization until the maximum number of group iterations is reached, and obtaining the global optimal solution for each group, i.e. is the mission sequence of each group after optimization.

Based on the further improvement of the above method, the performance record value of the selected neighborhood operator, the global optimal solution and the current round iteration optimal solution are updated according to the global optimal solution, the current round iteration optimal solution, the previous round iteration optimal solution and the second solution, including: updating the current-round iteration optimal solution using the second solution if the current-round iteration optimal solution is empty; if the objective function value of the second solution is less than the objective function value of the global optimal solution, updating the global optimal solution using the second solution by increasing the performance record value of the selected neighborhood operator based on the value of the first weight update factor; if the objective function value of the second solution is smaller than the objective function value of the optimal solution of the current round iteration, updating the optimal solution of the current round iteration using the second solution, by increasing the performance record value of the selected neighborhood operator according to the value of the second weight update factor; if the objective function value of the second solution is smaller than the objective function value of the optimal solution of the previous iteration, increasing the performance record value of the selected neighborhood operator according to the value of the third weight update factor; wherein the value of the first weight update factor is greater than the value of the second weight update factor, and the value of the second weight update factor is greater than the value of the third weight update factor.

Based on the further improvement of the above method, the weights of each neighborhood operator are updated according to the pre-defined weight update rate and the recorded value of the performance of each neighborhood operator by the following formula:

$${ω}_{p} = ρ * {ω}_{p} + ( 1 - ρ ) * {σ}_{p}$$

Where ωₚ denotes the weight of the pth neighborhood operator, σᵢ denotes the performance record value of the pth neighborhood operator; ρ denotes the weight update rate, 0≤ ρ≤1.

Based on further improvements of the above method, the neighborhood operators including: an Or-Opt operator for randomly selecting fragments containing three consecutive customers and reinserting the segments into other positions; a fragment swapping operator for swapping fragments of any length in two mission sequences.

A three-node position swap operator for randomly selecting 2 customers c1, c2 on one mission sequence and a customer c3 on another mission sequence, inserting customer c3 into the position of customer c1, inserting customer c1 into the position of customer c2 and inserting customer c2 into the position of customer c3.

On the other hand, embodiments of the present invention provide a large-scale UAV mission planning system, comprising: an objective construction module for constructing an objective function and constraints thereof for the UAV mission planning; a mission construction module for initializing a mission sequence and inserting each customer into the respective mission sequence with the smallest objective function value based on the change value of the objective function value after the insertion of the customer in the mission sequence, to obtain a plurality of initial mission sequences; a mission update module for iteratively performing the following update operations on the plurality of initial mission sequences: dividing the plurality initial mission sequences into the plurality of groups using a spectral clustering algorithm; according to the preset neighborhood operator, using the adaptive variable neighborhood search algorithm to optimize the mission sequences of each group of the plurality of groups in turn and then merging them to obtain a plurality of global mission sequences; if the total objective function value of the plurality of global mission sequences is less than the total objective function value of the plurality of initial mission sequences, updating the plurality of initial mission sequences using the plurality of global mission sequences; performing the next round of update operation until the end condition is reached, and forming the optimal UAV mission with the updated plurality of initial mission sequences.

Compared with some implementations, the present invention can achieve at least one of the following beneficial effects.
I. By use of a spectral clustering method to extract the relevance knowledge of each mission sequence, the relevance knowledge are mapped onto the feature space so that the similar mission sequences are grouped into the same group, so as to realize the partitioning of the large-scale problem, reduce the scale of the problem, lower the computational complexity and improve the computational speed.
II. By use of the adaptive variable neighborhood search algorithm for each group to solve the problem, the adaptive mechanism selects the neighborhood for the next search according to the neighborhood and the relevance knowledge of the solution, so as to make the neighborhood search more efficient, avoid falling into local optimum and obtain the global optimum solution while accelerating the convergence of the algorithm.
III. Starting from minimizing the accumulated time of UAV distribution, taking into account the capacity of UAV power and carrying supplies, the optimal mission allocation sequence is quickly obtained and planned, which has important practical significance for shortening the waiting time of material distribution and efficiently planning the UAV distribution mission.

In the present invention, the above technical solutions can also be combined with each other to achieve more preferred combination solutions. Other features and advantages of the present invention will be set forth in the subsequent specification, and some of the advantages may become apparent from the specification or be understood by implementing the present invention. The objects and other advantages of the present invention may be realized and obtained by the specification and in what is particularly indicated in the accompanying illustrations.

### BRIEF DESCRIPTION OF THE DRAWINGS

The accompanying drawings are used for the purpose of illustrating specific embodiments only and are not considered to be limiting to the present invention; throughout the accompanying drawings, the same reference symbols indicate the same components.

FIG. 1 is a flow chart of a large-scale UAV mission planning method in Example 1 of the present invention.

FIG. 2 is a flow chart of the update of the initial mission sequence in embodiment 1 of the present invention.

FIG. 3 shows a flowchart of optimization of the mission sequence for each group in embodiment 1 of the present invention.

FIG. 4 is a distribution diagram of warehouses and customers in the example scenario in Example 1 of the present invention.

FIG. 5 shows a distribution diagram of the initial mission sequence planned for the example scenario in Example 1 of the present invention.

FIG. 6 is a distribution diagram of the optimal mission assignment sequence planned for the example scenario in Example 1 of the present invention.

### DETAILED DESCRIPTION

Preferred embodiments of the present invention are specifically described below referring to the accompanying drawings, wherein the accompanying drawings form a part of the present application and are used in conjunction with embodiments of the present invention to illustrate the principles of the present invention and are not intended to limit the scope of the present invention.

### Example 1

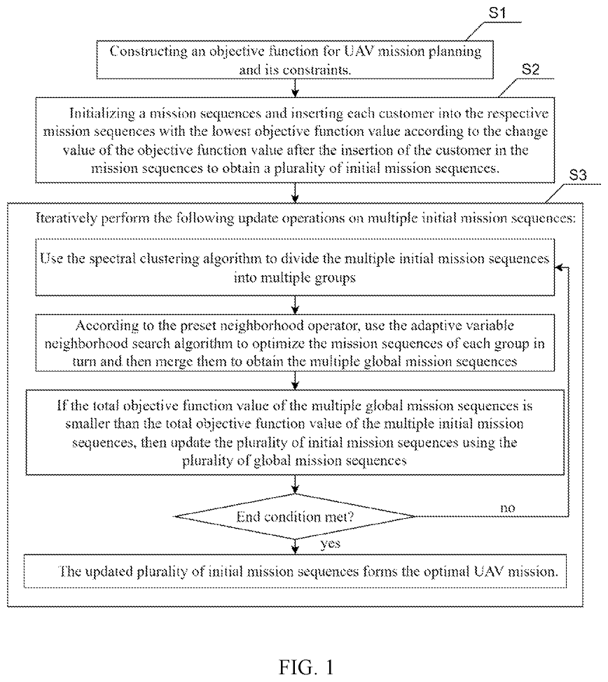

A specific embodiment of the present invention discloses a large-scale UAV mission planning method, as shown in FIG. 1, comprising the following steps.

S1: Constructing an objective function of the UAV mission planning and its constraints.

It is noted that the large-scale drone scenario of this embodiment includes the existence of multiple warehouses each of which has multiple drones and customers. UAV mission planning means planning a mission sequence for each drone in each warehouse so that each drone departs from the warehouse and the shortest total cumulative time for all mission sequences is achieved while ensuring that each customer is served only once, wherein the total accumulated time is the total waiting time of all customers on the mission sequence before they are served. The UAV departs from the warehouse, visits only one customer and returns to any warehouse. The UAV flight speed is uniform, and the UAV flight distance and the capacity of carrying supplies are limited.

Based on the above scenario, C is set to denote the customer point set; D denotes the warehouse point set; V=C∪D denotes the concatenation of the customer and warehouse point sets; R denotes the set of available drones; Q denotes the capacity of the supplies carried by the drone, and E denotes the battery capacity of the drone.

Taking the time for each UAV to reach a customer as the cumulative time and the shortest total cumulative time for each UAV to reach each customer in the mission sequence from the warehouse as the objective, the objective function of the UAV mission planning is constructed and expressed by the following equation.

$$minimize f ( x ) = {\sum }_{k ∈ R} {\sum }_{i ∈ C} {T}_{i}^{k} \qquad Equation ( 1 )$$

where Tᵢ^{k} denotes the time of arrival of drone k at the ith customer node, which is the accumulated time before the ith customer node receives the service.

It should be noted that the large-scale UAV mission planning includes a plurality of UAV mission sequences; each UAV mission sequence departs from the warehouse and returns to the warehouse, but the total accumulated time does not take into account the time that the UAV returns to the warehouse from the last customer in the mission sequence.

Further, constraints are constructed based on the number of times each customer is visited, the time for the UAV to reach the customer in the same mission sequence, the maximum capacity of the UAV to carry supplies, and the remaining power of the UAV to reach each customer. The constraints include:
(a) There can be only one mission sequence from customer i to customer j, which is expressed by the following equation:

$${\sum }_{k ∈ R} {\sum }_{i ∈ V} {x}_{ij}^{k} = 1 , ∀ j ∈ C \qquad Equation ( 2 )$$

where xᵢⱼ^{k} denotes whether drone k visits node j from node i. If it does, it takes 1, otherwise it takes 0, expressed in the following equation:

$${x}_{ij}^{k} ∈ \{ 0 , 1 \} , ∀ i , j ∈ V , i \neq j , ∀ k ∈ R \qquad Equation ( 3 )$$

(b) Any UAV must leave after visiting a customer, expressed by the following equation:

$${\sum }_{i ∈ V} {x}_{ij}^{k} = {\sum }_{i ∈ V} {x}_{ji}^{k} , ∀ j ∈ C , ∀ k ∈ R \qquad Equation ( 4 )$$

(c) Any UAV must depart and terminate from the warehouse, expressed by the following equation:

$${\sum }_{i ∈ D} {\sum }_{j ∈ V} {x}_{i j}^{k} = {\sum }_{i ∈ D} {\sum }_{j ∈ V} {x}_{j i}^{k} = 1 , ∀ k ∈ R \qquad Equation ( 5 )$$

(d) The demand of the customers served by any one UAV cannot exceed the maximum capacity of the supplies it carries, expressed by the following equation:

$${\sum }_{i ∈ V} {\sum }_{j ∈ C} {x}_{i j}^{k} \cdot {q}_{j} \leq Q , ∀ k ∈ R \qquad Equation ( 6 )$$

where qⱼ denotes the demand of the j-th node;
(e) If the drone visits customer j from customer i, then the time for the drone to reach the customer i must be less than the time to reach customer j;

$${T}_{i}^{k} + {t}_{i j} - ( 1 - {x}_{i j}^{k} ) \cdot M \leq {T}_{j}^{k} , ∀ i ∈ V , ∀ j ∈ C , ∀ k ∈ R \qquad Equation ( 7 )$$

where tᵢⱼ denotes the time taken by the UAV to reach the j-th node from the i-th node and M is the pre-defined maximum function value, for example, M=9999999999.
(f) If the drone visits customer j from customer i, then the remaining power of the drone at customer i must be greater than the remaining power at customer j, as expressed by the following equation:

$${b}_{i}^{k} - {α}_{ij} + ( 1 - {x}_{i j}^{k} ) \cdot M \geq {b}_{j}^{k} , ∀ i ∈ V , ∀ j ∈ C , ∀ k ∈ R \qquad Equation ( 8 )$$

where bᵢ^{k} denotes the remaining power of the drone k when it reaches the i-th node; αᵢⱼ denotes the power consumed by the drone to reach the j-th node from the i-th node.
(g) After visiting a customer point, the UAV must have a surplus of power to return to the warehouse, expressed by the following equation:

$${b}_{i}^{k} - {α}_{ie} \cdot {x}_{i e}^{k} \geq 0 , ∀ i ∈ C , ∀ e ∈ D , ∀ k ∈ R \qquad Equation ( 9 )$$

(h) The time of arrival of the UAV at the warehouse is 0. Since the return arrival at the warehouse is not considered, this constraint indicates that the time of departure of the UAV from the warehouse is 0, expressed by the following equation:

$${T}_{i}^{k} = 0 , ∀ i ∈ D , ∀ k ∈ R \qquad Equation ( 10 )$$

(i) The time for the UAV to reach any node should be greater than 0, expressed by the following equation:

$${T}_{i}^{k} \geq 0 , ∀ i ∈ V , ∀ k ∈ R \qquad Equation ( 11 )$$

(j) The UAV departs with a full charge and the starting power is its battery capacity, expressed by the following equation:

$${b}_{i}^{k} = E , ∀ i ∈ D , ∀ k ∈ R \qquad Equation ( 12 )$$

(k) The remaining power of the UAV reaching any node should be less than its battery capacity, expressed by the following equation:

$${b}_{i}^{k} \leq E , ∀ i ∈ V , ∀ k ∈ R \qquad Equation ( 13 )$$

It should be noted that when calculating the objective function value of any mission sequence, if the current mission sequence satisfies all constraints, the objective function value is calculated according to the objective function of Equation (1); otherwise, the objective function value is set to the pre-set maximum function value, such as 99999999.

The obtained information of drones, warehouses and customers is pre-processed to get the information in the objective function and its constraints. For example: constructing a collection of customers, warehouses, drones, and customers and warehouses; obtaining the time required for the drones to travel between any two nodes, the power consumed and the material capacity based on the location information of the warehouses and customers, the flight speed of the drones and the customer demand.

It should be noted that this embodiment starts from minimizing the accumulated time of drone delivery, taking into account the capacity of drone power and carrying supplies, which is more suitable for existing practical application scenarios.

S2: Initializing the mission sequence, and according to the change value of the objective function value after the insertion of customers in the mission sequence, each customer is inserted into the mission sequence with the smallest value of the respective objective function to obtain a plurality of initial mission sequences.

Specifically, the following steps are included:

1. For each UAV, a plurality of first mission sequences are constructed using the warehouse to which it belongs as the starting point of the mission sequence; all customers are put into the set to be inserted.

It should be noted that N warehouses, each containing M drones, are initially constructed with M×N first mission sequences, and each first mission sequence initially includes only the corresponding warehouse to which the drone belongs. Exemplarily, the first mission sequence corresponding to UAV A of warehouse d₀ is {d₀}.

2. Perform the following update operation for multiple first mission sequences iteratively: inserting each customer in the set to be inserted into each first mission sequence in turn, calculating the change value of the objective function value of each first mission sequence before and after the insertion, and obtaining the difference between the second minimum change value and the minimum change value; comparing the difference value corresponding to each customer, inserting the customer with the largest difference value into the end of the first mission sequence of the minimum change value corresponding to that customer, and deleting the customer from the set to be inserted, and performing the next update operation until the set to be inserted is empty.

It should be noted that when there is no second minimum change value, the minimum change value is taken as the difference value. The second smallest change value is the second smallest change value, and the change value of the objective function value of each first mission sequence before and after insertion is calculated as the insertion cost of the customer. This step first finds the difference value of the insertion cost corresponding to each customer from all mission sequences, and then finds the customer with the largest insertion cost difference by the difference value, and inserts it to the end of the mission sequence with the smallest insertion cost of the customer.

Exemplarily, the first mission sequence {d₀} is updated to {d₀,c₁} after inserting customer c₁, and then updated to {d₀,c₁,c₂} after inserting customer c₂.

3. From the updated plurality of first mission sequences, the first mission sequence containing customers is filtered, and the warehouse closest to the last customer is inserted at the end of the filtered plurality of first mission sequences, respectively, as the mission sequence endpoint to obtain the plurality of initial mission sequences.

Exemplarily, at the end of the first mission sequence {d₀, c₁, c₂}, the warehouse d₁ nearest to the last customer c₂ is inserted to obtain {d₀, c₁, c₂, d₁} as the initial mission sequence.

It should be noted that the warehouse at the end of the mission sequence can be the same as the warehouse at the beginning of the mission sequence.

S3: the following update operations are performed iteratively for multiple initial mission sequences: the spectral clustering algorithm is used to divide the multiple initial mission sequences into multiple groups; according to the preset neighborhood operator, the adaptive variable neighborhood search algorithm is used to optimize the mission sequences of each group of the multiple groups in turn and then merge them to obtain the multiple global mission sequences; if the total objective function value of the multiple global mission sequences is smaller than the total objective function value of the multiple initial mission sequences, the multiple initial mission sequences are updated using the multiple global mission sequences; the next round of update operation is performed until the end condition is reached, and the updated multiple initial mission sequences are the optimal UAV mission.

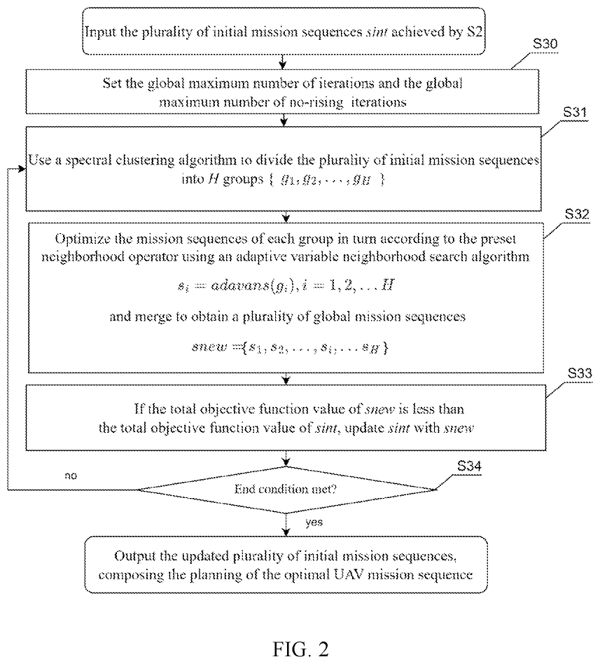

It should be noted that this step is a global iterative process to continuously optimize the initial mission sequence sint, as shown in FIG. 2, including the following steps:

S30, setting the global maximum number of iterations and the global maximum number of no-rising iterations.

S31, using a spectral clustering algorithm to divide the plurality of initial mission sequences into multiple groups.

Compared with the prior algorithm, this step uses the spectral clustering algorithm to extract the relevance knowledge of each mission sequence and maps the relevance knowledge to the feature space so that the similar mission sequences are divided into the same group, which realizes the partitioning of the problem and reduces the scale of the problem.

S32, according to the pre-set neighborhood operator, the adaptive variable neighborhood search algorithm is used to obtain a plurality of global mission sequences by merging the mission sequences of each group after optimizing them in turn.

Compared with some implementations, this step is used to apply the adaptive variable neighborhood search algorithm to each group, and the adaptive mechanism selects the neighborhood for the next search based on the relevance knowledge of the neighborhood and the solution, which makes the neighborhood search more efficient and prevents the results from falling into local optimum while accelerating the convergence of the algorithm.

S33, if the total objective function value of the plurality of global mission sequences is less than the total objective function value of the plurality of initial mission sequences, the plurality of global mission sequences is used to update the plurality of initial mission sequences.

Preferably, a local search algorithm is used to iteratively repair each global mission sequence in turn using each neighborhood operator, and the repaired mission sequence with the smallest total objective function value is taken to update the corresponding global mission sequence; after obtaining the repaired plurality of global mission sequences, the total objective function values of the plurality of global mission sequences and the total objective function values of the plurality of initial mission sequences are then compared.

If the objective function value of the multiple global mission sequences is greater than or equal to the objective function value of the multiple initial mission sequences, it means that the performance is not improved and the number of no performance improvement iterations is incremented by 1; otherwise, the performance is improved and the number of no performance improvement iterations is 0.

S34, determining whether the end condition is reached, if not, returning to step S31 to perform the next round of update steps, otherwise, obtaining the updated plurality of initial mission sequences and composing them as the optimal UAV mission sequence.

It should be noted that the end conditions include: the number of iterations reaches the global maximum number of iterations, or, the number of no-boost iterations reaches the global maximum number of no-boost iterations.

Specifically, step S31 comprises:

1. Calculating, as an input sample, the coordinates of the center of gravity of each initial mission sequence based on the coordinates of the latitude and longitude where each node in each initial mission sequence is located, and the number of customers and warehouses, by means of the following formula:

$${b}_{m} = ( {b}_{m}^{x} , {b}_{m}^{y} ) = ( \frac{1}{\vert {V}_{m} \vert} {\sum }_{i ∈ {V}_{m}} {x}_{i} , \frac{1}{\vert {V}_{m} \vert} {\sum }_{i ∈ {V}_{m}} {y}_{i} ) \qquad Equation ( 14 )$$

where (bₘ^{x},bₘ^{y}) denotes the longitude coordinates and latitude coordinates of the center of gravity bₘ of the m-th mission sequence Vₘ; |Vₘ| denotes the number of nodes in the mth mission sequence, and the nodes include customers and warehouses; xᵢ denotes the longitude coordinates of the i-th node; yᵢ denotes the latitude coordinates of the i-th node.

The input samples corresponding to the K initial mission sequences are {b₁, b₂, . . . ,bₘ, . . . ,b_{K}}.

2. Constructing the similarity matrix W and the degree matrix D from the input samples.

It should be noted that each element of the similarity matrix W is calculated by the following equation:

$${w}_{m n} = e ( \frac{{‖ {b}_{m} - {b}_{n} ‖}_{2}}{2 {σ}^{2}} ) \qquad Equation ( 15 )$$

where ∥bₘ−bₙ∥₂ represents the distance between the center of gravity in the m-th mission sequence and the center of gravity in the n-th mission sequence, and σ is an adjustable parameter.

The degree matrix D=diag(d₁, d₂, . . . , dₘ, . . . , d_{K}), where dₘ=Σₘ₌₁^{K}wₘₙ, i.e., each element of the degree matrix is defined as the sum of the weights of all the edges connected to it.

3. Computing the Laplace matrix L=D−W, L∈R_{K×K}.

4. The eigenvalues of the Laplacian matrix L are calculated, and the eigenvectors, corresponding to the lk eigenvalues, are selected from the minimum eigenvalues according to the pre-defined number of eigen dimensions lk, to form the eigenmatrix F, F∈R_{K×lk}; each row in F represents an lk-dimensional data point.

5. The feature matrix F is clustered using the k-means clustering method, and the K initial mission sequences are divided into H groups {g₁, g₂, . . . , g_{H}}, each group containing multiple initial mission sequences.

It should be noted that the mission sequences are not duplicated among the groups and are independent of each other,

$$H = ⌈ \frac{C}{B} ⌉$$

C denotes the total number of customers, B denotes the pre-defined number of customers in each group, and └·┘ is rounded up.

Step S31 is to partition the large-scale problem into a plurality of smaller problems and cluster them in terms of mission sequences, with the number of customers contained in each mission sequence being uncertain, and the actual customers contained within each group obtained after clustering are approximated as B. The mission sequences in each group are independent from each other and do not overlap.

It is to be noted that step S32 is to iteratively optimize the mission sequences of each group obtained at step S31 through a two-layer iterative process using a pre-determined neighborhood operator.

It is to be noted that the neighborhood operators of this embodiment include eight types, described as follows:
a node position reset operator, used to remove a customer node from its original position and randomly select another mission sequence or a position on that mission sequence to insert that customer;
a node position exchange operator, used to exchange the positions of two customer nodes in different mission sequences;
2-2 Exchange operator, used to exchange two segments containing two consecutive customers in different mission sequences;
a Segment-Node Swap operator, used to randomly select a customer in one mission sequence and two adjacent customers in another mission sequence and exchange their positions;
an Or-Opt operator, used to randomly select segments containing three consecutive customers and reinsert them into other positions;
a fragment swapping operator, used to swap fragments of any length in two mission sequences;
a three-node position swapping operator, used to randomly select 2 customers c1 and c2 on one mission sequence and a customer c3 on another mission sequence, insert customer c3 into the position of customer c1, and insert customer c1 into the position of customer c2 and inserting customer c2 into the position of customer c3;
a node reinsertion operator, used to calculate the change & of the objective function of the solution after each customer node is removed from the original position, select out the first 3 customer nodes with the largest & values, and insert these 3 customer nodes in order into the position that causes the least increase in the objective function of the solution.

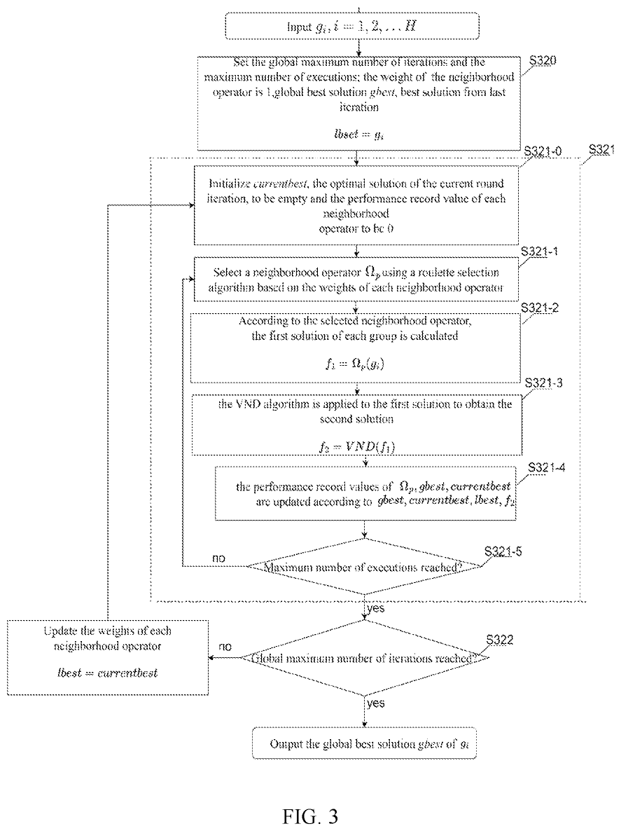

Further, step S32 optimizes the mission sequences of each group in turn according to the preset neighborhood operator using an adaptive variable neighborhood search algorithm, that is, iterates through each group and optimizes each group using step S320-step S322 as shown in FIG. 3 to obtain the optimized mission sequences of each group, and merge them to obtain a plurality of global mission sequences as the output of step S32.

Specifically, step S32 performs the following iterative optimization operations for each mission sequence of each group.

S320, initializing the data of each group, including: the global optimal solution gbest, the previous iteration optimal solution Ibest, the neighborhood operator weights, the maximum number of executions and the maximum number of group iterations.

It should be noted that the first level of iterative optimization operation is performed for each group in turn according to the group maximum iteration number; the second level of neighborhood search operation is performed in each round of iterative optimization operation for each group according to the maximum execution number. The maximum number of executions in each round of iterative optimization operations is set according to the number of pre-defined neighborhood operators.

At the same time, the mission sequence of each group obtained from step S31 is used as the initial global optimal solution and the previous iteration optimal solution, and the weight of each neighborhood operator is initialized to 1. The previous iteration optimal solution is the optimal solution of the previous iteration of each group in the iterative optimization operation of the first layer; the global optimal solution is the optimized mission sequence at step 32 for the mission sequence of each group, i.e., the mission sequence obtained after reaching the maximum number of iterations of the group.

S321, the iterative adaptive variable neighborhood search operation is performed for the mission sequence of each group until the maximum number of executions is reached, and the optimal solution of the previous iteration is updated for each group using the optimal solution of the current round of iterations, and the weights of each neighborhood operator are updated according to the preset weight update rate and the performance record value of each neighborhood operator.

Specifically, at each execution of adaptive variable neighborhood search, including:
S321-0, initializing currentbest, the optimal solution of the current round iteration, to be empty and the performance record value of each neighborhood operator to be 0;
S321-1, selecting a neighborhood operator using a roulette selection algorithm based on the weights of each neighborhood operator, where the roulette selection probability of each neighborhood operator is the ratio of the weights of each neighborhood operator to the sum of the weights of all neighborhood operators;
S321-2, according to the selected neighborhood operator, the first solution of each group is calculated; that is, according to the selected neighborhood operator, a position in that neighborhood operator satisfying the constraint is randomly selected to update the mission sequence of each group to obtain the first solution;
S321-3, the variable neighborhood descent algorithm (VND, Variable Neighborhood Descent) is applied to the first solution to obtain the second solution, wherein the neighborhood operator used in VND is all the neighborhood operators for finding the solution with the highest performance over the input solution. If the optimal solution of the current iteration is empty, the second solution is used to update the optimal solution of the current iteration.

As can be understood, the first solution is the mission sequence obtained after adjusting the positions of customer nodes in the mission sequence of each group according to the selected neighborhood operator, and the second solution is the mission sequence obtained after adjusting the positions of customer nodes in the mission sequence of the first solution according to the VND algorithm. The total objective function value of the mission sequence of the second solution is less than or equal to the total objective function value of the mission sequence of the first solution.

S321-4, the performance record values of the selected neighborhood operator, the global optimal solution and the current round iteration optimal solution are updated according to the global optimal solution, the current round iteration optimal solution, the previous round iteration optimal solution and the second solution.

Specifically, the update is performed according to the following judgments in turn.

If the objective function value of the second solution is smaller than the objective function value of the global optimal solution, the performance record value of the selected neighborhood operator is increased according to the value of the first weight update factor, and the global optimal solution is updated using the second solution.

If the objective function value of the second solution is smaller than the objective function value of the optimal solution of the current round iteration, the performance record value of the selected neighborhood operator is increased according to the value of the second weight update factor, and the optimal solution of the current round iteration is updated using the second solution.

If the objective function value of the second solution is smaller than the objective function value of the optimal solution of the previous round iteration, the performance record value of the selected neighborhood operator is increased according to the value of the third weight update factor.

The value of the first weight update factor is greater than the value of the second weight update factor, and the value of the second weight update factor is greater than the value of the third weight update factor.

It is noted that the value of the weight update factor is preset for increasing the weight of the selected neighborhood operator based on the performance improvement of the second solution.

S321-5, determining whether the maximum number of executions is reached, if not, updating each group using the global optimal solution and returning to S321-1 for the next execution, otherwise, completing a round of iterative optimization and executing step S322.

S322, determining whether the maximum number of group iterations is reached, if not, updating the previous round iteration optimal solution using the current round iteration optimal solution, updating the weights of each neighborhood operator according to the preset weight update rate and the performance record value of each neighborhood operator, returning to step S321 for the next iteration optimization, otherwise, obtaining the global optimal solution gbest for each group, which is the optimized mission for each group sequence.

Specifically, the weights of each neighborhood operator are updated by the following formula, with the aim of giving more chances for the neighborhoods with larger performance gains to be selected.

$${ω}_{p} = ρ * {ω}_{p} + ( 1 - ρ ) * {σ}_{p} \qquad Equation ( 16 )$$

where ω_{ρ} denotes the weight of the p-th neighborhood operator, σᵢ denotes the performance record value of the p-th neighborhood operator; ρ denotes the weight update rate, 0≤ ρ≤1.

It should be noted that the adaptive variable neighborhood search in step S321 dynamically selects neighborhood operators mainly by the weights of the neighborhood operators and roulette selection probabilities, and updates different performance record values for the neighborhood operators by identifying the performance degree of the solution, so as to increase the weights of the neighborhood operators that can improve the performance, make the neighborhood search more efficient and prevent the results from falling into local optima while accelerating the convergence of the algorithm.

In step S33, a local search algorithm is used to iteratively repair each global mission sequence using each neighborhood operator in turn, and for each neighborhood operator, all feasible positions are traversed, and from all feasible positions of all neighborhood operators, the position that minimizes the objective function value of the mission sequence (i.e., the largest performance improvement) is selected to update the global mission sequence, and then compared the objective function value with all initial mission sequences obtained at step S2. If the objective function value of multiple global mission sequences is smaller than the objective function value of multiple initial mission sequences, the multiple global mission sequences are used to update the multiple initial mission sequences; otherwise, it means that the performance is not improved and the next round of global iterations is needed.

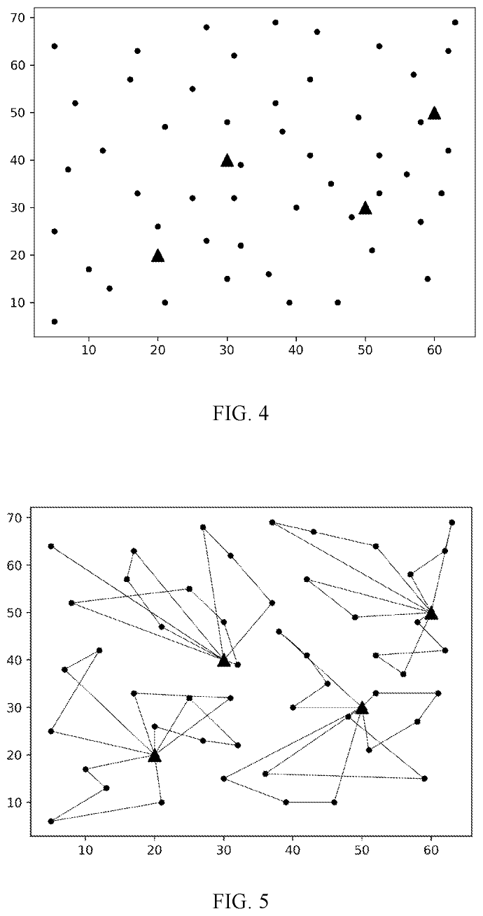

The following is an example of a specific application scenario to obtain optimal drone missions using the large-scale drone mission planning method of this embodiment. As shown in FIG. 4, the distribution of warehouses and customers in the example scenario, where the circle symbol indicates customers and the number is 50, and the triangle symbol indicates warehouses and the number is 4. Each warehouse contains 4 UAVs, and each UAV has a load carrying capacity of 80 and a battery capacity of 14, and the UAV battery consumption rate is ⅕ of the distance, i.e., every 5 units of distance flown consumes one unit of electricity, and the average value of 50 customer demands is 15.41, the minimum value of demand is 3, and the maximum value is 41.

The 16 initial mission sequences are obtained in step S2, as shown in FIG. 5, and the objective function value is 1077.26.

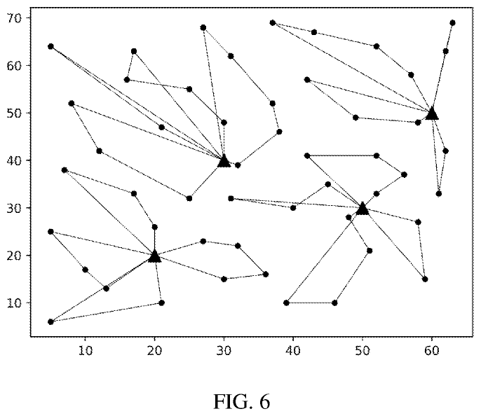

The global maximum number of iterations in the iteration end condition set in step S3 is 50 and the global maximum number of no-rising iterations is 5. In the global iteration process, the pre-set number of feature dimensions lk in step S31 is 20 and the pre-set number of customers B in each group is 20, dividing the 16 initial mission sequences into 3 groups. In step S32, the adaptive weight update rate ρ is set to 0.95, the values of the first, second and third weight update factors are 30, 10 and 5, respectively, and the maximum number of group iterations is 20. The convergence time of the algorithm in step S3 is about 40 s, and the total running time is about 95 s. After the end of the run, the 16 updated mission sequences are obtained to form the optimal UAV mission, as shown in FIG. 6, and the objective function value is 863.40. Comparing FIG. 5 and FIG. 6, it can be seen that there are fewer intersections between the mission sequences in the optimal UAV mission, and the mission sequences are more independent and reasonable, respectively.

Compared with some implementations, this embodiment provides a large-scale UAV mission planning method, which starts from minimizing the accumulated time of UAV distribution, taking into account the UAV power and the capacity of carrying supplies, and quickly plans an optimal mission sequence, which has important practical significance for shortening the waiting time of supplies distribution and efficiently planning UAV distribution missions. Among them, the relevance knowledge of each mission sequence is extracted using the spectral clustering method, and the relevance knowledge is mapped onto the feature space so that the similar mission sequences are grouped into the same group to realize the partition of the large-scale problem, which reduces the scale of the problem, decreases the computational complexity and improves the computational speed; each group is solved using the adaptive variable neighborhood search algorithm, and the adaptive mechanism selects next search neighborhood according to the relevance knowledge of solution and neighborhood, so as to make the neighborhood search more efficient and avoid falling into local optimum while speeding up the convergence of the algorithm to obtain the global optimum solution.

### Example 2

In another embodiment of the present invention, a large-scale UAV mission planning system is disclosed, thereby implementing the large-scale UAV mission planning method of Example 1. The specific implementation of the modules is referred to the corresponding description in Example 1. The system comprises:
an objective construction module for constructing an objective function for UAV mission planning and constraints thereof;
a mission construction module for initializing a mission sequence and inserting each customer into the mission sequence with the lowest value of the respective objective function according to the value of the change of the objective function value after the insertion of the customer in the mission sequence to obtain a plurality of initial mission sequences;
a mission update module for iteratively performing the following update operations on the plurality of initial mission sequences: using the spectral clustering algorithm to divide the plurality of initial mission sequences into a plurality of groups; according to the preset neighborhood operator, using the adaptive variable neighborhood search algorithm to optimize the mission sequences of each group of the plurality of groups in turn and then merging them to obtain a plurality of global mission sequences; if the total objective function value of the plurality of global mission sequences is smaller than the total objective function value of the plurality of initial mission sequences, then updating the plurality of initial mission sequences using the plurality of global mission sequences; performing the next round of update operation until the end condition is reached, and forming the optimal UAV mission with the updated plurality of initial mission sequences.

Since the present embodiment and the aforementioned large-scale UAV mission planning method embodiment are related to each other and are described herein repeatedly, they are not repeated here. Since the present system embodiment is based on the same principles as the method embodiment described above, the present system embodiment also has the corresponding technical effects of the method embodiment described above.

It is understood by those skilled in the art that all or part of the process of realizing the method of the above embodiment can be accomplished by means of a computer program to instruct the relevant hardware, and said program can be stored in a computer-readable storage medium. Wherein, said computer readable storage medium is a disk, CD, read-only storage memory or random storage memory, etc.

The above described is only a better specific implementation of the present invention, but the scope of protection of the present invention is not limited to it, and any variation or replacement that can be readily thought of by any person skilled in the art within the technical scope disclosed by the present invention shall be covered by the scope of protection of the present invention.

What is claimed is:

1. A method for large-scale unmanned aerial vehicle (UAV) mission planning, comprising:
constructing an objective function for UAV mission planning and its constraints;
initializing a mission sequence and inserting each customer into the respective mission sequence with the smallest objective function value according to the change value of the objective function value after the insertion of the customer in the mission sequence to obtain a plurality of initial mission sequences;
iteratively performing the following update operations on the plurality of initial mission sequences: using the spectral clustering algorithm to divide the plurality of initial mission sequences into a plurality of groups; according to the preset neighborhood operator, using the adaptive variable neighborhood search algorithm to optimize the mission sequences of each group of the plurality of groups in turn and then merging them to obtain a plurality of global mission sequences; if the total objective function value of the plurality of global mission sequences is smaller than the total objective function value of the plurality of initial mission sequences, then updating the plurality of initial mission sequences using the plurality of global mission sequences; performing the next round of update operation until the end condition is reached, and forming the optimal UAV mission with the updated plurality of initial mission sequences.

2. The method according to claim 1, further comprising: after merging to obtain the plurality of global mission sequences, a local search algorithm is used to iteratively repair each global mission sequence in turn using each neighborhood operator, and the repaired mission sequence with the smallest objective function value is taken to update the corresponding global mission sequence; the repaired plurality of global mission sequences are obtained.

3. The method according to claim 1, wherein said objective function for constructing the UAV mission planning and its constraints, comprises:
constructing an objective function with a cumulative time for each UAV to reach a customer and a minimum total cumulative time for each UAV to reach each customer in the mission sequence from the warehouse as the objective;
constructing constraints based on the number of times each customer is visited, the time for a drone to reach a customer in the same mission sequence, the maximum capacity of the supplies carried by the drone, and the remaining power of the drone to reach each customer;
when calculating the objective function value of any mission sequence, if the current mission sequence satisfies all the constraints, calculating the objective function value according to the objective function, otherwise, setting the objective function value to the pre-set maximum function value.

4. The method according to claim 3, wherein said initializing the mission sequence and inserting each customer into the respective mission sequence with the smallest objective function value based on the change value of the objective function value after inserting the customer in the mission sequence to obtain the plurality of initial mission sequences, comprises:
constructing, for each UAV, a plurality of first mission sequences using the warehouse to which it belongs as the starting point of the mission sequence; placing all customers into the set to be inserted;
iteratively performing the following update operations on the plurality of first mission sequences: inserting each customer in the set to be inserted into each first mission sequence in turn, calculating the change value of the objective function value of each first mission sequence before and after the insertion, and obtaining the difference between the second minimum change value and the minimum change value; comparing the difference value corresponding to each customer, inserting the customer with the largest difference value into the first mission sequence corresponding to the minimum change value of that customer and deleting the customer from the set to be inserted, and performing the next update operation until the set to be inserted is empty;
screening the first mission sequence containing the customer from the updated plurality of first mission sequences, and inserting the warehouse nearest to the last customer into the tail of the screened plurality of the first mission sequences as the end of the mission sequence, respectively, to obtain the plurality of initial mission sequences.

5. The method according to claim 1, wherein said using a spectral clustering algorithm to divide the plurality of initial mission sequences into a plurality of groups, comprises:
calculating, as input samples, the coordinates of the center of gravity of each initial mission sequence based on the coordinates of the latitude and longitude where each node in each initial mission sequence is located, and the number of customers and warehouses, by means of the following formula:
$${b}_{m} = ( {b}_{m}^{x} , {b}_{m}^{y} ) = ( \frac{1}{\vert {V}_{m} \vert} {\sum }_{i ∈ {V}_{m}} {x}_{i} , \frac{1}{\vert {V}_{m} \vert} {\sum }_{i ∈ {V}_{m}} {y}_{i} )$$
where (bₘ^{x},bₘ^{y}) denotes the longitude coordinates and the latitude coordinates of the center of gravity bₘ of the m-th mission sequence Vₘ; |Vₘ| denotes the number of nodes in the m-th mission sequence, said nodes including customers and warehouses; xᵢ denotes the longitude coordinates of the i-th node; yᵢ denotes the latitude coordinates of the i-th node;
inputting the input samples, the pre-defined number of feature dimensions and the number of customers in each group into a spectral clustering algorithm to cluster the plurality of initial mission sequences into the plurality of groups.

6. The method according to claim 1, wherein said adaptive variable neighborhood search algorithm is used to sequentially optimize the mission sequences of each group according to the pre-set neighborhood operator, comprises:
performing the following iterative optimization operations on the mission sequence of each group: initializing the global optimal solution, the optimal solution of the previous round iteration and the neighborhood operator weights, and setting the maximum number of executions;
in each execution, selecting a neighborhood operator by use of a roulette wheel selection algorithm based on the weights of each neighborhood operator; calculating a first solution for each group based on the selected neighborhood operator; obtaining a second solution by applying a variable neighborhood descent algorithm to the first solution;
updating the performance record values of the selected neighborhood operator, the global optimal solution and the current round iteration optimal solution based on the global optimal solution, the current round iteration optimal solution, the previous round iteration optimal solution and the second solution, updating each group with the global optimal solution for the next execution until the maximum number of executions is reached, updating the previous round iterative optimal solution for each group with the current round iterative optimal solution, updating the weights of each neighborhood operator according to the preset weight update rate and the performance record value of each neighborhood operator, and carrying out the next round of iterative optimization until the maximum number of group iterations is reached, and obtaining the global optimal solution for each group, which is the mission sequence of each group after optimization.

7. The method according to claim 6, wherein said updating the performance record value of the selected neighborhood operator, the global optimal solution and the current round iteration optimal solution, based on the global optimal solution, the current round iteration optimal solution, the previous round iteration optimal solution and the second solution, comprises:
updating the current-round iteration optimal solution using the second solution if the current-round iteration optimal solution is empty;
if the objective function value of the second solution is less than the objective function value of the global optimal solution, updating the global optimal solution using the second solution, by increasing the performance record value of the selected neighborhood operator based on the value of the first weight update factor;
if the objective function value of the second solution is smaller than the objective function value of the optimal solution of the current round iteration, updating the optimal solution of the current round iteration using the second solution, by increasing the performance record value of the selected neighborhood operator according to the value of the second weight update factor;
if the objective function value of the second solution is smaller than the objective function value of the optimal solution of the previous round iteration, increasing the performance record value of the selected neighborhood operator according to the value of the third weight update factor;
wherein the value of the first weight update factor is greater than the value of the second weight update factor, and the value of the second weight update factor is greater than the value of the third weight update factor.

8. The method according to claim 6, wherein the weights of each neighborhood operator are updated according to a preset weight update rate and the recorded performance value of each neighborhood operator by the following formula:
$${ω}_{p} = ρ * {ω}_{p} + ( 1 - ρ ) * {σ}_{p}$$
where ω_{ρ} denotes the weight of the p-th neighborhood operator, σᵢ denotes the performance record value of the p-th neighborhood operator; ρ denotes the weight update rate, 0≤ ρ≤1.

9. The method according to claim 1, wherein the neighborhood operator comprises:
an Or-Opt operator for randomly selecting segments containing three consecutive customers and reinserting the segments into other positions;
a fragment swapping operator for exchanging fragments of any length in a sequence of two missions;
a three-node position swap operator for randomly selecting 2 customers c1 and c2 on one mission sequence and one customer c3 on another mission sequence, inserting customer c3 into the position of customer c1, inserting customer c1 into the position of customer c2, and inserting customer c2 into the position of customer c3.

10. A large-scale UAV mission planning system, comprising:
an objective construction module for constructing an objective function and constraints thereof for the UAV mission planning;
a mission construction module for initializing a mission sequence and inserting each customer into the mission sequence with the lowest value of the respective objective function according to the change value of the objective function value after the insertion of the customer in the mission sequence, to obtain a plurality of initial mission sequences;
a mission update module for iteratively performing the following update operations on the plurality of initial mission sequences: using the spectral clustering algorithm to divide the plurality of initial mission sequences into a plurality of groups; according to the preset neighborhood operator, using the adaptive variable neighborhood search algorithm to optimize the mission sequences of each group of the plurality of groups in turn and then merging them to obtain a plurality of global mission sequences; if the total objective function value of the plurality of global mission sequences is smaller than the total objective function value of the plurality of initial mission sequences, then updating the plurality of initial mission sequences using the plurality of global mission sequences; performing the next round of update operation until the end condition is reached, and forming the optimal UAV mission with the updated plurality of initial mission sequences.
